(19) United States
(12) Patent Application Publication
(10) Pub. No.: US 2015/0173566 A1
(43) Pub. Date: Jun. 25, 2015

(54) TAMPER HOLDER

(71) Applicant: Vita-Mix Corporation, Olmsted Township, OH (US)

(72) Inventor: Phonesacksith Guy Kettavong, Kent, OH (US)

(21) Appl. No.: 14/577,391

(22) Filed: Dec. 19, 2014

Related U.S. Application Data
(60) Provisional application No. 61/918,512, filed on Dec. 19, 2013.

(51) Int. Cl. A47J 47/16; B01F 15/00; A47J 43/07; F16M 13/02

(52) U.S. Cl. CPC A47J 47/16; F16M 13/02; B01F 15/00; A47J 43/07; B01F 2215/0022

(57) ABSTRACT

A blending system is provided, having various innovative features. The blending system may include a tamper for use in stirring any foodstuffs in a container. The blending system may have a tamper holder configured to receive a tamper while the tamper is not in use. The tamper holder may include an attachment pad configured to attach to a pedestal of a blender base of the blending system. At least one arm may extend off of the attachment pad. The arm may have a clasp for receiving the tamper. The clasp may be c-shaped or any other shape that allows for the receiving of the tamper. The arm may have a bumper extending perpendicularly from the arm to a base and a spill moat extending in an opposite direction of the bumper.

### CROSS-REFERENCE TO RELATED APPLICATION

This application claims the benefit of U.S. Provisional Patent Application Ser. No. 61/918,512, filed Dec. 19, 2013, and entitled “TAMPER HOLDER,” the entirety of which is incorporated herein by reference.

### TECHNICAL FIELD

The present invention relates to a blending system having a tamper adapted for use with the blending system and, more particularly, to a holder for the tamper when it is not in use.

### BACKGROUND

Blenders and blending systems are often used to blend and process foodstuffs. Frozen, frosty, or icy drinks have become increasingly popular. Such drinks include the traditional shakes, and the more recently popular smoothies. Shakes, or milk shakes, are typically formed of ice-cream and/or milk, and flavored as desired, with or without additives, such as candies, chocolates, peanut butter, fruits, etc. Milkshakes typically are available at most fast-food restaurants, such as burger chains, and may be made by special machines, or hand-made using mixers.

Smoothies tend to be healthier, and are formed of ice, frozen yogurt, and/or sorbet, and also may include additives such as fruits, fruit juice, vitamins, supplements, etc. Smoothies typically are available from specialty chains or juice bars, and may be made with commercial or restaurant-grade blender. Such drinks also may be made at home, using a personal blender. One disadvantage with making such drinks, or utilizing blenders, is the difficulty in operating the blender due to the specific ingredients required in some recipes. Blenders often get clogged. or otherwise stalled by the drink ingredients. It is often necessary to supplement the blending by stirring the ingredients with a spoon or spatula. The spoon or spatula may get caught in. the blades of the blender. A user may also use a stir stick. or tamper to stir the ingredients. Any of these options requires the user to go to a different location in the kitchen to obtain the spoon., spatula, or tamper. The user may not want to leave a blender unattended so shutting off the blender prior to obtaining a spoon, spatula, or tamper is an added step to the blending process and may extend the blending time. Further, it is possible that the user may not be able to find a spoon, spatula, or tamper quickly, or even at all.

Therefore, a need exists for an improved means for securing a stirring utensil, e.g., a tamper, to the blender itself for easy retrieval when needed.

### SUMMARY

The following presents a simplified summary of the specification to provide a basic understanding of some aspects of the specification. This summary is not an extensive overview of the specification. It is intended to neither identify key or critical elements of the specification nor delineate any scope particular to any embodiments of the specification, or any scope of the claims. Its sole purpose is to present some concepts of the specification in a simplified form as a prelude to the more detailed description that is presented later.

A blending system is provided, having various innovative features. The blending system may include a tamper for use in stirring any contents (e.g., foodstuffs) in a container. The blending system may have a tamper holder configured to receive a tamper while the tamper is not in use. The tamper holder may include an attachment pad configured to attach to a pedestal of a blender base of the blending system. The attachment pad may be any appropriate shape depending on the shape and diameter of the pedestal to which the attachment pad is configured attach or fit around. At least one arm may extend off of the attachment pad. The arm may be of a length to extend past the side of the blender base. The arm may have a clasp component for receiving the tamper. The clasp component may be c-shaped or any other shape that allows for the receiving of the tamper. The arm may also have a support or bumper extending perpendicularly from the arm to the blender base and a spill moat extending in an opposite direction of the support. The spill moat may be a solid surface configured to support a base of the tamper held by the tamper holder. The arm may be a solid surface that supports the side of the tamper held by the tamper holder, to prevent the tamper from moving, e.g., during the use of the blender.

The following description and the drawings set forth certain illustrative aspects of the specification. The drawings indicated a few of various embodiments that may utilize certain aspects of this disclosure. While some improvements and novel aspects may be specifically identified, others will be apparent from the detailed description.

### DESCRIPTION OF THE DRAWINGS

The accompanying drawings illustrate various systems, apparatuses, devices and methods, in which like reference characters refer to like parts throughout, and in which:

FIG. 1 is a front view of a tamper holder in accordance with various embodiments described here;

FIG. 2 is a front perspective view of a tamper holder attached to a blender system with a tamper attached to the tamper holder in accordance with various embodiments described here;

FIG. 3 is a side perspective view of a tamper holder attached to a blender system in accordance with various embodiments described here;

FIG. 4 is a back view of a tamper holder in accordance with various embodiments described here;

FIG. 5 is a side cross sectional view of a tamper holder in accordance with various embodiments described here;

FIG. 6 is an elevated side view of a tamper holder in accordance with various embodiments described here;

FIG. 7 is a side view of a tamper holder in a folded configuration, in accordance with various embodiments described here;

FIG. 8 is an elevated perspective view of a tamper holder in a folded configuration and a packaging, in accordance with various embodiments described here;

FIG. 9 is an elevated perspective side view of a tamper holder comprising a rigidly or semi-rigidly connected arm in accordance with various embodiments described here;

FIG. 10 is an elevated perspective side view of a tamper holder comprising a non-removable bumper in accordance with various embodiments described here;

FIG. 11 is a top view of a tamper holder attached to a blender system with a tamper attached to the tamper holder in accordance with various embodiments described here;

FIG. 12 is a cross sectional side view of a tamper holder having a swinging connection in accordance with various embodiments described here;

FIG. 13 is an elevation view of a tamper holder comprising a shortened attachment pad in accordance with various embodiments described here; and

FIG. 14 is an elevation view of a tamper holder comprising a c-shaped attachment pad in accordance with various embodiments described here;

FIG. 15 is an elevation view of a tamper holder comprising an attachment strap in accordance with various embodiments described here;

FIG. 16 is an side view of a portion of a tamper holder comprising an arm attached to an attachment pad in accordance with various embodiments described here;

FIG. 17 is a side view of a portion of a tamper holder comprising a movable spill moat and clasp component in accordance with various embodiments described here;

FIG. 18 is a flow diagram of an exemplary method associated with attaching a tamper holder to a larger system in accordance with various embodiments described here; and

FIG. 19 is a flow diagram of an exemplary method associated with packaging or storing of a tamper holder in accordance with various embodiments described here.

### DETAILED DESCRIPTION

Reference will now be made in detail to exemplary embodiments, examples of which are illustrated in the accompanying drawings. It is to be understood that other embodiments may be utilized and structural and functional changes may be made. Moreover, features of the various embodiments may be combined or altered. As such, the following description is presented by way of illustration only and should not limit in any way the various alternatives and modifications that may be made to the illustrated embodiments. In this disclosure, numerous specific details provide a thorough understanding of the subject disclosure. It should be understood that aspects of this disclosure may be practiced with other embodiments not necessarily including all aspects described herein, etc.

As used herein, the terms tamper, stir stick, agitator, and the like are used interchangeably unless context warrants a particular distinction among such terms. For instance, the terms may refer to an object or tool that can agitate, stir, or tamp contents in a blender container. Such objects or tools may include spoons, spatulas, tampers, pestles, and the likes. Accordingly, it is noted that embodiments referencing a tamper are not limited by a particular type or design of a tamper. As such, it is noted that appropriate modifications may be made based on a desired tamper.

It is noted that the various embodiments described herein may include other components and/or functionality. It is further noted that while various embodiments refer to a blender or a blender system, various other systems may be utilized in the scope and spirit of embodiments described herein. For example, embodiments may be utilized in food processor systems, mixing systems, hand-held. blending systems, coffee grinders, various other food preparation systems, non-food mixing systems, and the likes. As such, references to a blender, blender system, and the like, are understood to include food processor systems, non-food mixing systems, and the likes. Furthermore, while blending of “contents” or “foodstuffs” described by various embodiments, it is noted that non-food stuff may be mixed or blended, such as paints, epoxies, construction material. (e.g., mortar, cement, etc.), and the likes.

Aspects of systems, apparatuses or processes described herein generally relate blending or mixing systems. In an embodiment, a blending system c may include a tamper holder. The tamper holder may receive and hold a tamper or other object. For example, a user may interact with a blender. The user may use a tamper to stir or agitate contents within a container of the blender (e.g., a container). The user may then place the tamper in the tamper holder to securely store the tamper and reduce spillage around a workspace. Further, the user may reduce steps of retrieving a tamper from a drawer, dirtying a table or counter top, and the likes. Such may lead to improved user satisfaction and more efficient blending systems.

In embodiments, a tamper holder may include an attachment pad that may attach (e.g., removably or irremovably) or couple with a base of a blending system. The tamper holder may also include a drainage or spill moat that may support the tamper when the tamper is attached or held by the tamper holder. In another aspect, the tamper holder may include a clip that secures the tamper and a bumper component that may interface with a body or base of the blending system. In at least one embodiment, the tamper holder may comprise a cutout design that may allow contents or spillage to drain or be cleared from the tamper holder.

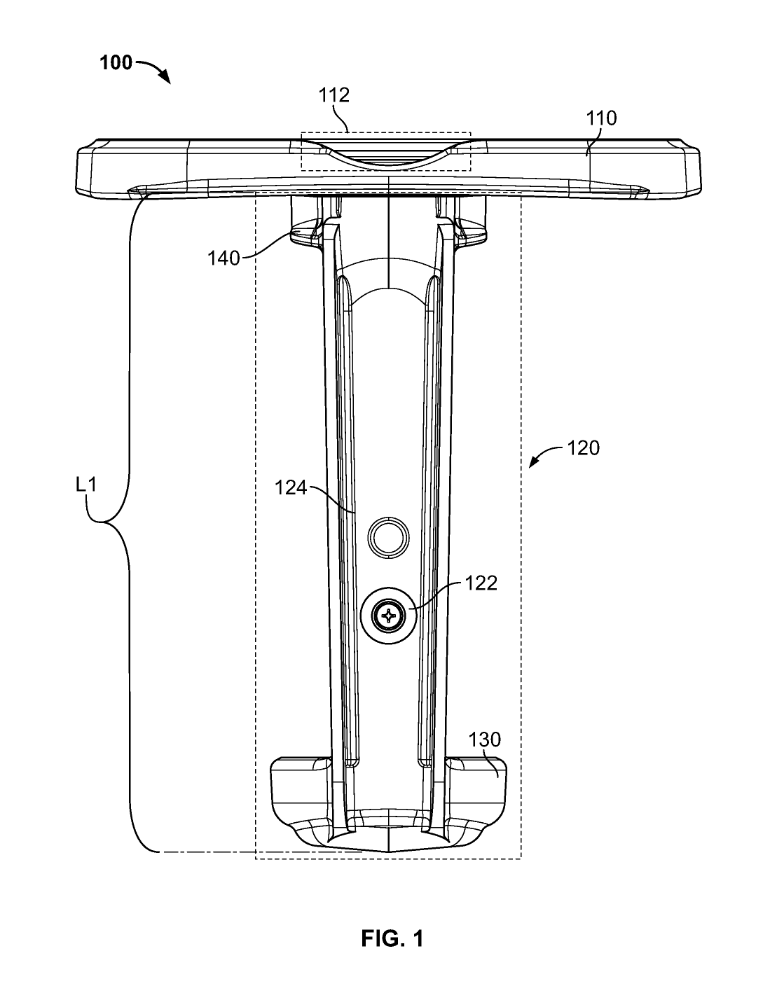

Referring now to FIG. 1, there depicted is non-limiting diagram of front view of a tamper holder 100. Tamper holder 100 may primarily include attachment pad 110 (which may attach to a blender base), an arm 120, a spill moat 130 (which may support a tamper and collect food contents), and a clasp component 140 (which may secure and support the tamper). It is noted that tamper holder may comprise a plurality of arms, spill moats, clasp components, and the likes.

Tamper holder 100 may include or be comprised of one or more materials, such as food grade plastics, metals, rubbers, and the like. For example, one or more of attachment pad 110, arm 120, spill moat 130, or clasp component 140 may be made of polyesters, copolyester (e.g., TRITAN), or the likes. Furthermore, one or more portions of tamper holder 100 may comprise a non-stick coating, such as polytetrafluoroethylene (e.g., TEFLON). In another aspect, tamper holder 100 may be monolithically formed or it may be formed by attaching or adhering the components set forth above together.

Attachment pad 110 may comprise a frame like or ring like shape that may be configured to at least partially fit around a pedestal of a blender base or a portion thereof. As used herein a ring of frame shape may refer to any appropriate shape, including, without limitation, circular, elliptical, rectangular, etc. In one or more embodiments, a ring shape may comprise a gap (e.g., U-shaped, c-shaped, etc.) in contrast to a complete ring (e.g., having no start or end point such as a circle or ellipse). The shape may depend on or otherwise correspond to the shape and dimensions of the pedestal to which the attachment pad 110 is configured to connect.

While various embodiments depict or describe attachment pad 110 connecting to a pedestal of a blender base, it is noted that attachment pad 110 may be configured to attach to other components or devices. For instance, attachment pad 110 may attach to a container (e.g., pitcher, bowl, cup, etc.) in which mixing or blending will occur. In another example, attachment pad 110 may be configured to attach to a blade assembly, which, in turn, attaches to a pedestal or other connection of a blender base. For sake of brevity, attachment pad 110 is described as attaching to a pedestal of a blender base. However, it is noted that such embodiments may be adapted in order to allow attachment pad 110 to attach to other components or devices.

As described in more detail below, dimensions of attachment pad 110 may be based on a particular blender or pedestal to which attachment pad 110 is to attach. In at least one embodiment, attachment pad 110 may be adjustable. Adjustability may be derived from a type of material utilized for construction (e.g., material with elasticity), a sliding mechanism, a clasp, buckle, or other component that may adjust a size of an opening and/or ring of attachment pad 110. In other embodiments, attachment pad 110 may be designed to attach to a specific blender make or model.

During blending of contents, some contents tend to spill or overflow. For example, when a user utilizes a tamper, contents being blended may stick to the tamper or otherwise spill from a container. As content drips, the content may be collect at or near a pedestal of a blending system and attachment pad 110 may receive spilled content. According to at least some embodiments disclosed herein, a clean out 112 portion of attachment pad 110 may allow for spilled contents or to exit or be cleaned out (e.g., manually by a user) of attachment pad 110. As described in more detail herein, clean out 112 may comprise a cut away portion forming a gap or dip in the attachment pad 110. Furthermore, attachment pad 110 may comprise groves that may direct or divert spilled contents to the cut away portion. It is noted that such grooves may be pitched to facilitate diversion of the spilled contents to the cut away portion.

While FIG. 1 depicts the clean out 112 as being at an opposite side of attachment pad 110 compared to arm 120, it is noted that clean out 112 may be positioned at various other portions of attachment pad 110 (e.g., other sides, corners, etc.). For example, clean out 112 may be positioned such that contents flows toward arm 120 and collects in or is received by spill moat 130. Furthermore, attachment pad 110 may comprise multiple cut away portions, cut away portions having different dimensions or shapes, and the likes. In many blender systems, a portion of the blender base may comprise a power cord, vent, fan, or other component from which a user may want any spilled contents to flow away. Thus, clean out 112 may be positioned such that spilled contents drains away from such components.

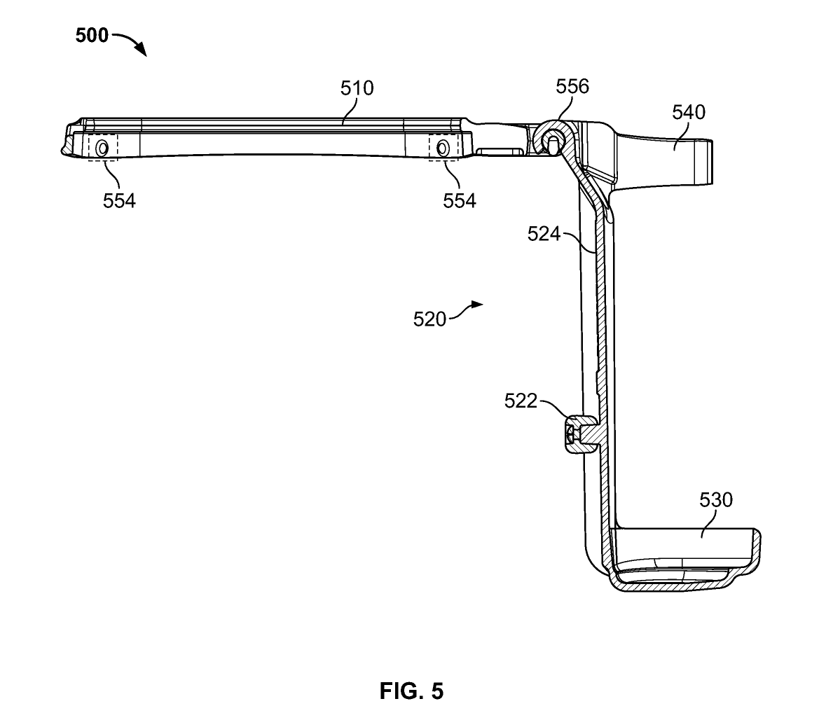

Arm 120 may be attached to or extend from attachment pad 110. In various embodiments, arm 120 and attachment pad 110 may be perpendicular or substantially perpendicular with each other. Arm 120 may also be adjustable such that arm 120 and attachment pad 110 are not perpendicular or substantially perpendicular. For instance, arm 120 may swing at a joint (arm attachment component 556 of FIG. 5).

Arm 120 may primarily comprise at least one support 124, at least one clasp component 140 (which may receive and maintain a tamper in a stored position, at least one spill moat 130 (which may support a tamper and receive spilled contents or dripped contents from a tamper), and at least one bumper 122 (which may align and stabilize tamper holder). Various components of the arm 120 will be described in more detail below. While embodiments herein describe a tamper holder comprising a support, it is noted that other embodiments may comprise no support 124 or different number of supports. For example, attachment pad 110 and/or clasp component 140 may attach to a blender base and spill moat 130 may separately attach to the blender base (e.g., without support 124 connecting the components). However, for sake of brevity, the various embodiments are described with support 124 or similar components.

Support 124 may be of any desired length. For instance, support 124 may be of a length L1 to extend past the side of the blender base. In another example, length L1 of support 124 may be based on a length(s) of a tamper(s). The length L1 of support 124 may be configured such that different types or sized tampers may be held by tamper holder 100. Furthermore, the length L1 of support 124 may be configured to allow a collar or other portion of a tamper to clear other components of a blender system (e.g., clasp component 140, a blender base, and the likes).

In some embodiments, the length L1 of support 124 may be adjustable, such as by a user or consumer. Adjustable lengths may allow for a broader range of tampers (or other objects) to be held by tamper holder 100. However, in at least one embodiment the length L1 of support 124 may be predetermined to accommodate tampers of different sizes. As utilized herein and unless context suggests otherwise, the length L1 of support 124 generally refers to the distance from spill moat 130 to clasp 140.

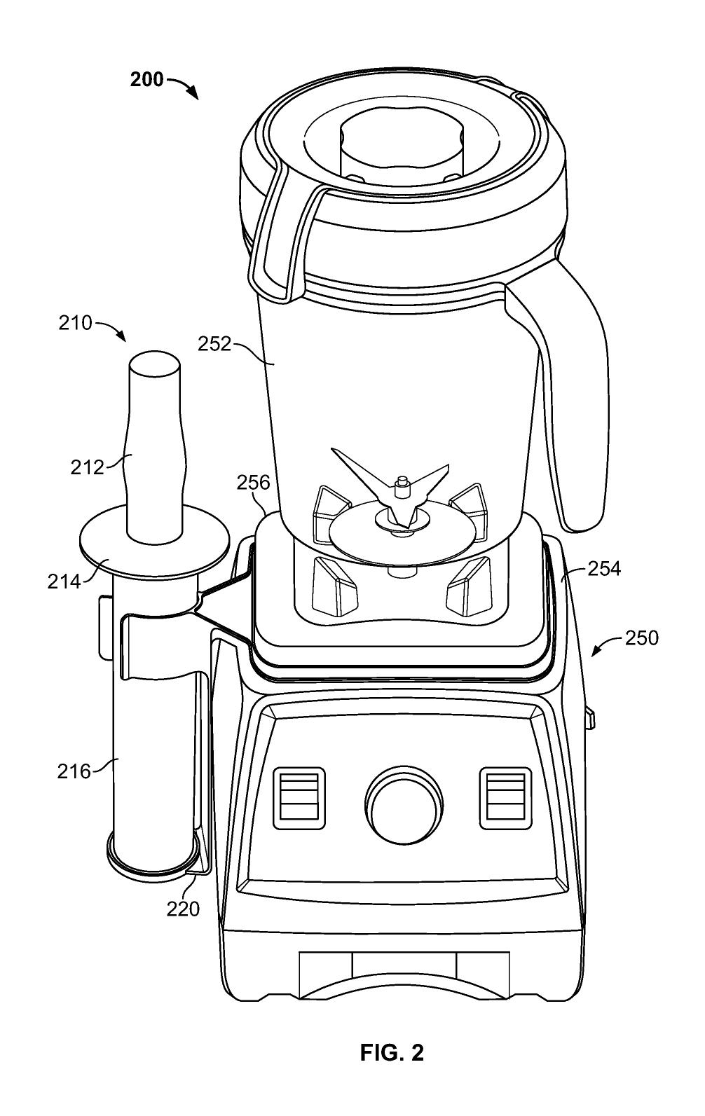

Turning now to FIG. 2, there illustrated is an exemplary blender system 200. Blender system 200 may blend, mix, or otherwise process food or other contents. As depicted, blender system 200 may primarily comprise blender base 250, container 252, pedestal 254, and tamper holder 220. The components of the blender system 200 may be made of any appropriate material, such as molded of a suitable plastic material or appropriate metals, such as brushed metal and stainless steel. It is noted that tamper holder 220 may comprise all or some components of various tamper holders described herein (e.g., tamper holder 100).

The blender base 250 may be any appropriate size and shape, such as generally cylindrical or generally rectangular. The blender base 250 may house various components such as a motor, gearing, a fan, vents, and other components to facilitate rotational movement required for blending. It is appreciated that blender base 250 may comprise various other components not shown for brevity.

In at least one embodiment, the blender base 250 may include a pedestal 254 at its top. The pedestal 254 may be sized and shaped to engage a container 252, such as generally rectangular or generally circular. The pedestal 254 may include one or more components, such as a sensor, to provide a safety lock. The container 252 may be configured to hold the foodstuffs being agitated by the blending system 200. It is noted that container 252 may comprise a number of different containers, including a pitcher, a jar, a single serving container, and the like. Container 252 may be comprised of various materials (e.g., glass, plastics, etc.). Likewise, container 252 may include a nonstick coating, gradient markings, a lid, a handle, and the likes.

The blending system 200 may include a tamper 210 for use in stirring, agitating, etc., any foodstuffs or non-foodstuffs in the container 252. The tamper 210 may be of any appropriate shape or design. By way of a non-limiting example, the tamper 210 may be shaped like a smooth, rounded rod. In at least one embodiment, tamper 210 may comprise a handle portion 212, a collar portion 214, and an agitating portion 216. In use, a user may hold handle portion 212 and insert agitator portion 216 into an opening in a lid of container 252. Collar portion 214 may prevent the user from inserting the tamper 210 too far into container 252 (e.g., to prevent contact between blades of blender system 200 and agitator potion 216). In various examples, the user may place tamper 210 in tamper holder 220 and/or remove tamper 210 from tamper holder 220. Such a configuration may allow for increased user satisfaction, decreased preparation time of foodstuff, decreased spillage, and/or increased sanitation or cleanliness.

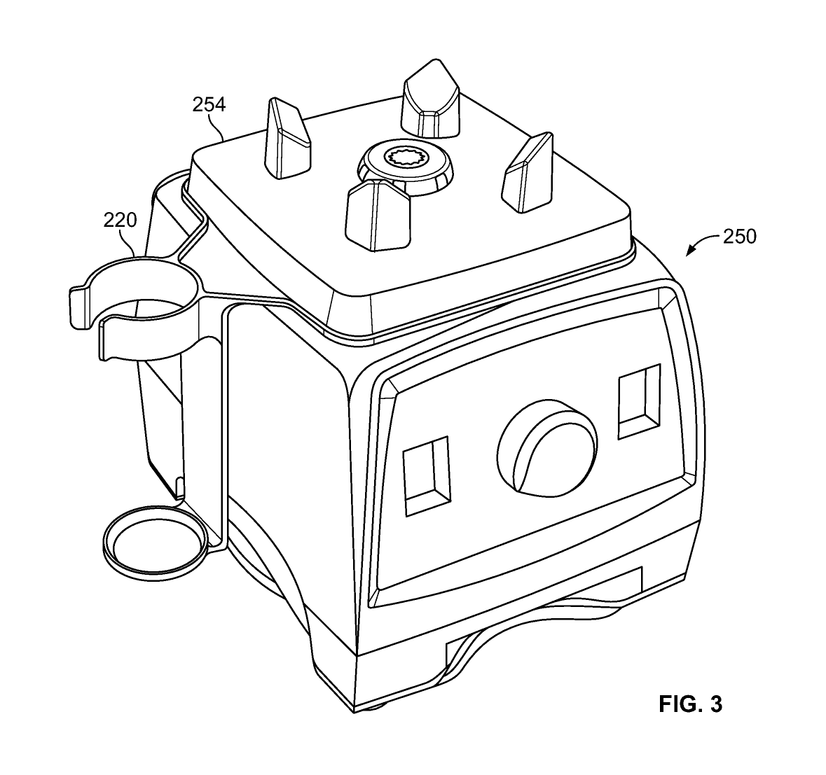

FIG. 3 depicts at least a portion of blender system 200. More particularly, FIG. 3 depicts blender base 250, tamper holder 220, and pedestal 254. As depicted, tamper holder 220 (e.g., via an attachment pad) may be attached to blender base 250 such that pedestal 254 fits above tamper holder 220.

In at least one other embodiment, tamper holder 220 may be attached to blender base 250 such that tamper holder 220 (e.g., an attachment pad of tamper holder 220) is above and attached to pedestal 254. It is noted that tamper holder 220 and pedestal 254 may be of a singular construction or may be of disparate constructions (as shown in FIG. 3). Furthermore, tamper holder 220 may be held in place via a connection with blender base 250, pedestal 254, or a container (e.g., container 252 of FIG. 2). For instance, tamper holder 220 may be positioned above pedestal 254 and a container may attach to or lock into place with pedestal 254. The connection between pedestal 254 and the container may secure tamper holder 220, such as via a connection pad 256.

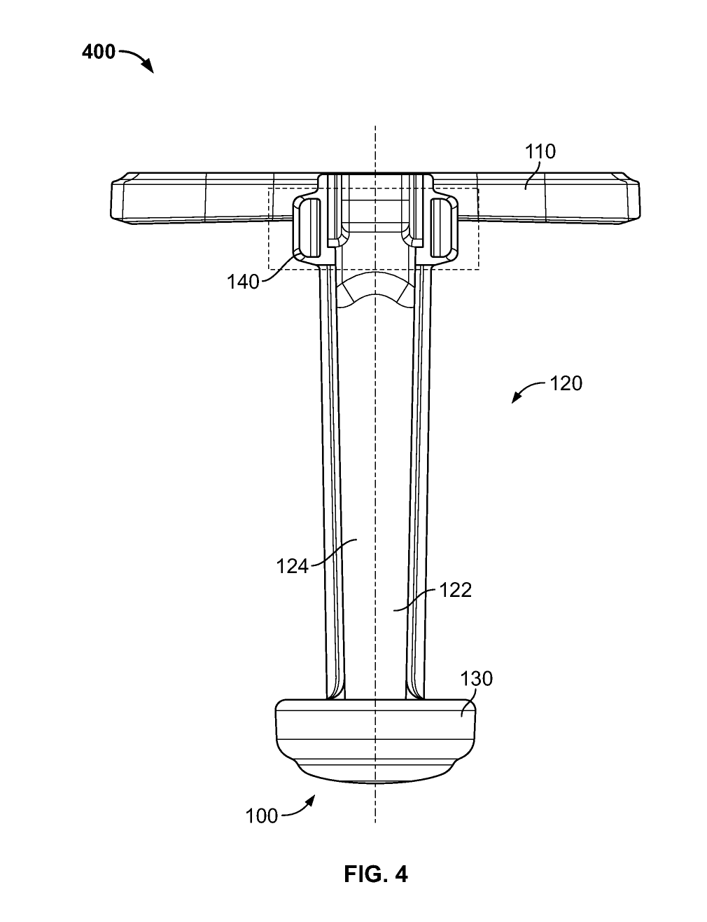

FIG. 4 depicts a non-limiting diagram of back view 400 of tamper holder 100. As noted herein, tamper holder 100 may primarily include attachment pad 110, arm 120, spill moat 130, and clasp component 140.

Clasp component 140 may extend from arm 120. In embodiments, clasp component 140 may be configured for receiving and maintaining a tamper (e.g., tamper 210) in a stored and substantially upright position. Clasp component 140 may be generally c-shaped or any other shape that allows for the receiving and holding of the tamper. Further, the ends of the clasp component 140 may be flared to allow for increased ability to place a tamper in the clasp component 140. It is noted that tamper holder 100 may comprise various other types of clasping mechanisms or securing mechanisms. For instance, tamper holder 100 may comprise a magnetic material configured to attract a magnetic material of a tamper. In another example, tamper holder 100 and a tamper may comprise a set of interlocking cleats (or teeth) that may connect to secure the tamper. Further embodiments of clasp component 140 may include VELCRO, elastic straps, spring clasps, threaded connections, and the like.

In at least one embodiment, clasp component 140 is not movable from a particular position along arm 120. Rather, clasp component 140 is an appropriate distance from spill moat 130 and/or from a top of attachment pad 110 to allow various tampers to be held. While clasp component 140 is depicted at or near attachment pad 110, clasp component 140 may be located at various other positions along arm 120. For instance, clasp component 140 may be located at a position based on a design of a tamper, such as to avoid a collar of a tamper. In another embodiment, the position of clasp component 140 may be adjustable or configurable by an end user. Adjusting the position of clasp component 140 may comprise sliding and locking clasp component 140, positioning clasp component 140 at predetermined positions (e.g., positions marked via a line, select positions that may lock clasp component 140 in place, etc.), and the likes. For example, markings on arm 120 may indicate preferred or suggested positions of clasp component 140 associated with a particular tamper.

It is noted that clasp component 140 may be removably connected to arm 120. A removable clasp may allow for easier storage, cleaning, replacement, or repositioning of clasp component 140. Further, clasp component 140 may be foldable or collapsible for storage, packaging, cleaning, and the likes. Moreover, while FIG. 4 depicts a single c-shaped clasp, it is noted that tamper holder 100 may comprise other numbers of clasps. Further, tamper holder 100 may comprise clasps of different dimensions. For example, a first clasp may have a first diameter and a second clasp may have a second diameter that is different from the first diameter. The first or second clasp may be used based on a size of a tamper or a need to stabilize a tamper during blending.

Spill moat 130 may be located at a distal end of arm 120. Spill moat may provide support to a tamper when the tamper is held by tamper holder 100. Further, spill moat 130 may comprise a bowl shape and may be configured to collect foodstuff or other material that spills or drips off of the tamper and/or spills from a blending system. Similar to clasp component 140, a position of spill moat 130 may be adjustable. Likewise, spill moat 130 may be removably connected to arm 120. It is noted that dimensions of spill moat 130 may be determined based on a desired configuration.

FIG. 5 depicts a non-limiting diagram of a right side cross-sectional view of a tamper holder 500. Unless context suggests otherwise or warrants a particular distinction among the components, liked name components of FIG. 5 and various figures (e.g., FIGS. 1, 2, 3, etc.) may comprises similar aspects or functionality.

Tamper holder 500 may include an attachment pad 510. Attachment pad 510 may include one or more coupling components 554 (e.g., cleats, teeth, threaded couplings, clasps, etc.) that may connect with receiving members of a blender base (e.g., blender base 250), pedestal (e.g., pedestal 254), container (e.g., container 252), or the likes. As depicted, coupling components 554 may comprise cleats that are protrusions, hooks, or tabs, which may be received by an appropriate mating or receiving member. When or during pressing attachment pad 510 into place, coupling components 554 may provide a tactile feed-back as cleats or other coupling components snap or lock into place. In another aspect, coupling components 554 may provide an audible feed-back (e.g., a clicking noise) or a visual feed-back that signifies that coupling components 554 are fully engaged and attachment pad 510 is in place. Feed-back may assist a user in determining whether attachment pad 510 is completely and correctly connected to a blender system (e.g., blender system 200).

In an example, coupling components 554 may comprise a number of cleats located on an inner surface of an attachment pad 510. A user may place the attachment pad 510 on a base of a blender system. The user may then apply pressure that may cause the cleats to snap into place (e.g., via a grove or receiving member comprised by the blender base). The snapping may produce a tactile, visual, or audible feed-back.

It is noted that the various embodiments may comprise different types, numbers, position, and configurations of coupling components 554. For instance, different blender systems may comprise different means of attachment on a blender base, pedestal, or container. Based on the differences in means of attachment, coupling components 554 may vary.

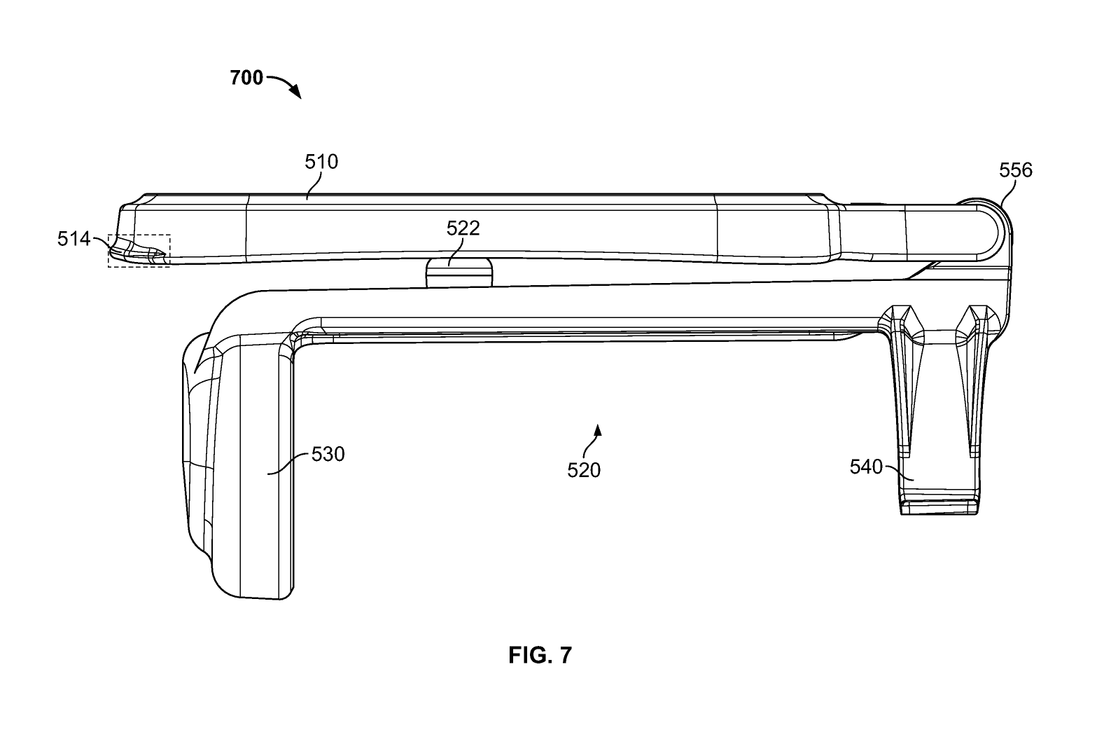

Although not shown, attachment pad 510 may comprise a tab or flap (e.g., flap 514 of FIG. 7) may allow for easier removal or detachment of attachment pad 510. For instance, when attachment pad 510 is attached to a blender system, a user may have some difficulty gripping or otherwise removing the attachment pad 510, such as for cleaning. A tab (e.g., protrusion or flap) may provide added means for gripping or removing attachment pad 510.

An arm attachment component 556 may provide for removal/attachment or adjustment of arm 520. Arm attachment component 556 may include a threaded member and locking mechanism (e.g., screw/bolt and nut), a pin, a ball joint, a semi-flexible or bendable material, and the likes. In some embodiments, a user may adjust an angle of the connection of arm 520 and attachment pad 510 via arm attachment component 556. It is noted that the angle may be adjusted such that arm 520 is biased towards a blender base. The bias may cause arm 520 to exert a pressure or force on a blender base (e.g., at bumper 522) when tamper holder 500 connected with the blender base.

Bumper 522 may comprise a protrusion that extends from arm 520 in the direction of a blender base (when attached). The bumper 522 may align arm 520 with a blender base such that the arm 520 is parallel or substantially parallel with the blender base (or a portion thereof) and provide means of supporting and stabilizing arm 520. It is noted that other alignments may be utilized, such as aligning arm 520 to be perpendicular with a plane (e.g., table top, etc.). It is noted that dimensions of bumper 522 may depend on a desired distance between arm 520 and a blender base. For instance, bumper 522 may be sufficiently thick to allow arm 520 to extend a distance away from a blender base, such as to allow for a tamper or portion thereof (e.g., collar) to be held without interfering with other components of a blender system. For example, bumper 522 may be a determined thickness to keep arm 520 a target distance away from a blender base such that a collar of a tamper does not contact the blender base, clasp component 540, or a container.

In at least one embodiment, the bumper 522 may be constructed of a rubber or plastic material that may perpendicularly extend from arm 520. While bumper 522 is depicted as connected to arm 520, it is noted that bumper 522 may be connected to a blender base or other component of a blender system. Furthermore, tamper holder 500 may comprise a different number of bumpers.

Bumper 522 may be removably or irremovably connected to arm 520. For example, bumper 522 and arm 520 may monolithically formed or may be formed by attaching or adhering the components set forth above together. In various embodiments, bumper 522 may be adhered via an adhesive, screwed, snapped, or otherwise attached to arm 520. For instance, a screw may be threaded into arm 520. Bumper 522 may be snapped or installed overtop of a head of the screw. In another embodiment, a screw may be inserted or threaded through bumper 522 and then into arm 520. Indentations or markers may allow for proper alignment of bumper 522.

Bumper 522 may be adjustable to alter a pitch, distance of protrusion from arm 520, location of bumper 522 with respect to arm 520, or the likes. In at least one embodiment, bumper 522 may be reversible such that a first side of the bumper faces arm 520 in a first position and a second side of bumper 522 faces arm 520 in a second position. Each side may be associated with a particular pitch or distance of protrusion from arm 520. Likewise, each position may be associated with a particular blender system or side of a blender system. For example, a left side of a blender base (e.g., base 250) may be substantially perpendicular with a ground plane or attachment pad 510, while a left side of the blender base is pitched or irregularly shaped. Adjusting bumper 522 may allow tamper holder 500 to be configured in a position to hold a tamper in a vertical or upright position.

In another embodiment, bumper 522 may be associated with a locking or connecting mechanism of a blender base (e.g., base 250). For instance, bumper 522 may comprise a metallic substance that attracts to a blender base or a portion of a blender base. In other examples, bumper 522 may fit into a divot, snap into a connector, screw into a place, or otherwise connect to the blender base.

Arm 520 may comprise one or more materials. Inner material 524 may comprise a material having greater durability or structural strength than other material. For instance, inner material 524 (shaded area) may be a metal or other material. While other material (shown as non-shaded areas in FIG. 5) may comprise a food grade plastic or other material (e.g., TRITAN).

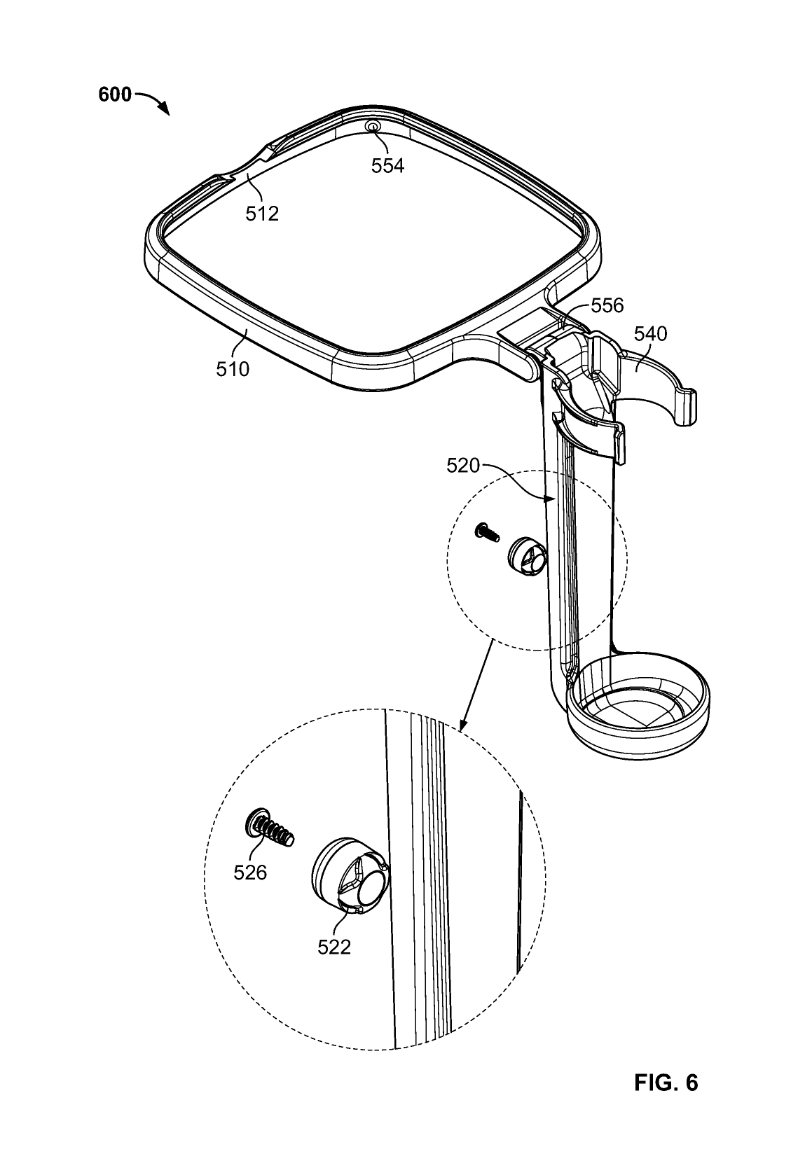

FIG. 6 depicts a prospective view 600 of tamper holder 500, with an expanded view of bumper 522 being attached or secured to arm 520. Bumper 522 may be attached to arm 520 via a bolt or screw 526. The screw 526 may be inserted in an opening of bumper 522 and may attach to a threaded receiving member of arm 520 (not shown).

As depicted, clasp component 540 may comprise a c-shaped clamp or clasp having flared tips for easy insertion of a tamper. It is appreciated that clasp component 540 may be generally circular or otherwise closed, such that a tamper may slide into clasp component 540.

Tamper holder 500 may further comprise a clean out portion 512. Clean out 512 may allow spilled contents (e.g., from a blender system) to flow out of or be wiped away from tamper holder 500. Removal of spilled contents may allow for increased sanitary conditions and provide for increased user satisfaction. Clean out 512 may be positioned at any location along attachment pad 510. As depicted, clean out 512 may be on an opposite side of attachment pad 510 as arm 520. When content is removed from clean out 512, the content may avoid contact with arm attachment component 556 and thereby prevent or reduce the amount of content which may be trapped in arm attachment component 556.

In various other embodiments, clean out 512 may be positioned in other locations along attachment pad 510. For instance, clean out 512 may be positioned at or near a corner, at an adjacent side of attachment pad 510 as arm 520, on the same side of attachment pad 510 as arm 520, or at any other desired positions. It is noted that the position of clean out 512 may be determined based on locations of other components, such as a fan of a blender system, a power cord, a control panel (e.g., buttons, switches, touch screens, knobs, etc.), or the likes. For example, a position of clean out 512 may be selected to divert spilled contents from contacting a fan or control panel when tamper holder 500 is connected to a blender base.

FIG. 7 depicts a left side view 700 of tamper holder 500 in a folded configuration. Attachment pad 510 may connect with arm 520 via arm attachment component 556. In an aspect, arm attachment component 556 may comprise a hinge formed via a portion of arm 520 and attachment pad 510. However, as described herein, arm attachment component 556 may comprise various other configurations. It is further noted that attachment component 556 may include a locking mechanism to lock arm in place.

Arm attachment component 556 may allow for folding tamper holder 500 for storage, cleaning, packaging, shipping, and the like. Folding tamper holder 500 may alter (e.g., reduce) the space need for storage of tamper holder 500. In another aspect, folding of tamper holder 500 may reduce the potential of harming the structural integrity of one or more components of tamper holder 500 such as during transportation thereof.

In an example, arm 520 may be folded such that bumper 522 is moved towards attachment pad 510 and spill moat 530 and clasp component 540 extend downwards (e.g., arm 520 moves clockwise as shown in FIG. 7). Arm 520 may be moved such that arm 520 and attachment pad 510 are parallel or substantially parallel. It is noted that arm 520 may be configurations to be at other positions if desired.

In at least one other embodiment, tamper holder 500 may be configured such that arm 520 may be above attachment pad 510 when tamper holder 500 is in a folded configurations (e.g., arm 520 swings counter clock wise in FIG. 7). For instance, tamper holder 500 may have dimensions that allow folding such that clasp component 540 and spill moat 530 do not prevent arm 520 from being parallel or substantially parallel with attachment pad 510. For example, one or more of spill moat 530 or clasp component 540 may extend through an opening of attachment pad 510 when tamper holder 500 is folded. In another example, one or more of spill moat 530 or clasp component 540 may extend past an outer wall of attachment pad 510. In some embodiments where one or more of spill moat spill moat 530 or clasp component 540 is adjustable or movable, spill moat 530 or clasp component 540 may be moved so as to allow arm 520 to be folded without spill moat 530 or clasp component 540 obstructing the folding.

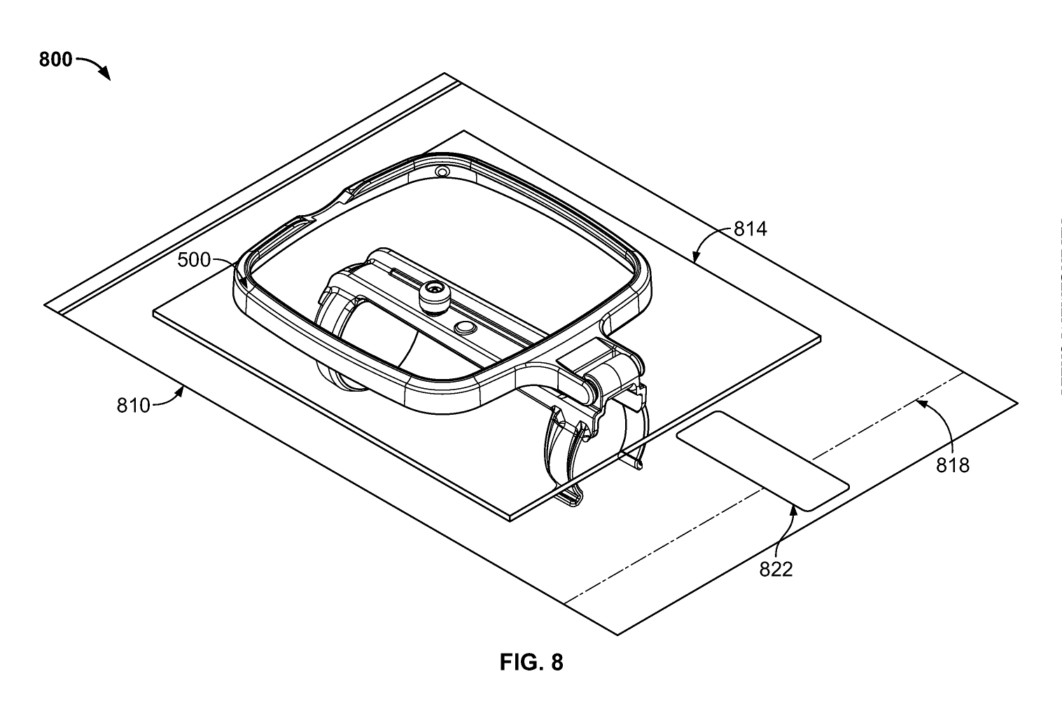

FIG. 8. depicts a packaging system 800 for packaging of tamper holder 500 in a folded configuration. Packaging system 800 may primarily comprise packaging 810, insert 814, and label 822. Packaging 810 may comprise a bag or an envelope (e.g., plastic, paper, etc.), or other container. In some embodiments, packaging 810 may comprise a wrap, such as shrink wrap.

Insert 814 may comprise a rigid, semi-rigid, or flexible material, such as paper, plastic, foam, cardboard, and the likes. Tamper holder 500 (or portions thereof) may be inserted into opening of insert 814 or otherwise connected to insert 814 (e.g., via twist ties, adhesive tape, etc.). For example, insert 814 may comprise a cardboard material having holes or gaps for receiving or holding spill moat 530 or clasp component 540. In another example, insert 814 may be positioned between arm 520 and attachment pad 510. Likewise, insert 814 may comprise an opening configured for receiving bumper 522.

Insert 814 may comprise printed information, radio frequency identification (RFID) tags, or other components. Printed information may comprise instructions, diagrams, barcodes, part numbers, and the likes. An RFID tag may be used for tracking, logistics, identification, and the like. In an aspect, the insert 814 may provide several functions, such as supporting tamper holder 500 during shipping, providing information, and protecting portions of tamper holder 500.

Insert 814 and tamper holder 500 may be inserted into packaging 810. An open side of packaging 810 may be folded as indicated by dashed line 818. Once folded, label 822 may hold packaging 810 closed. In some embodiments, label 822 may comprise a tamper proof label, printed information, RFID tags, and the likes. Further, label 822 may comprise at least one adhesive portion. It is noted that various embodiments may use other means of closing or sealing packaging 810 without limitation.

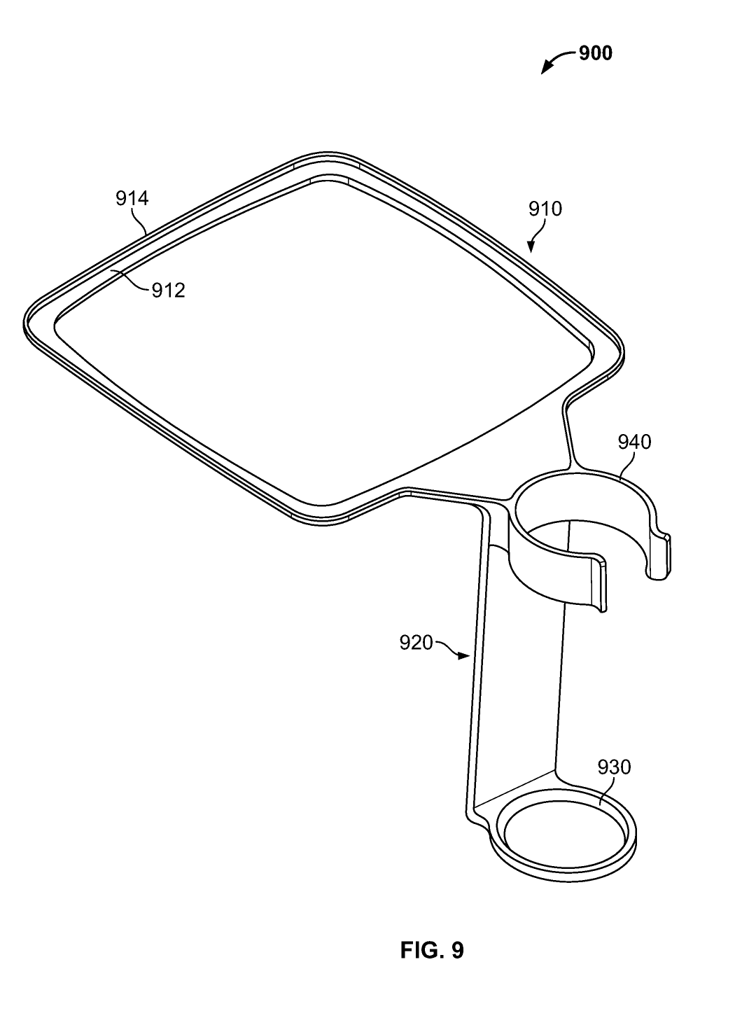

Turning to FIG. 9, there depicted is a prospective elevation view of tamper holder 900. Tamper holder 900 may comprise various components of other tamper holders described herein. It is further noted that like named components may comprise similar aspects or features unless context suggests otherwise.

As depicted, tamper holder 900 may primarily comprise attachment pad 910 and arm 920. Attachment pad 910 may be a ring or frame like component. Further, attachment pad 910 may comprise a ridge 914 that is raised in comparison with portion 912. Ridge 914 may direct the flow of spilled foodstuff to a clean out portion (not shown) or a particular area of attachment pad 910. Ridge 914 may also provide a mechanism for coupling or positioning with a blender base, pedestal, container, or other component. It is noted that the bottom side of attachment pad 910 (top side shown) may also comprise a ridge. The ridge of the bottom side may be utilized as a coupling component with a base or pedestal of a blender system.

In comparison with other embodiments disclosed here, tamper holder 900 is depicted without an arm attachment component (e.g., arm attachment component 556) or clean out (e.g., clean out 512). Furthermore, spill moat 930 comprises a different depth than those depicted in other embodiments. However, it is noted that spill moat 930 may be a flat. It is further noted that other modifications and/or features may be made based on desired embodiments. As such, the various embodiments described herein are exemplary and non-limiting embodiments. For example, spill moat 930 may be concave or convex depending on a desired configuration. In another example, spill moat 930 may comprise a locking mechanism, such as a channel lock, that interlocks with a tamper.

Various components of tamper holder 900 may be monolithically or may be formed by attaching or adhering the components set forth above together. As described herein, tamper holder 900 may be constructed of one or more materials, such as plastics, metals, TRITAN material, and the like. In some embodiments, tamper holder 900 may comprise a first substance coated or embedded in a second substance. For example, arm 920 may comprise a metal or other rigid material surrounded by a food grade material (e.g., TRITAN).

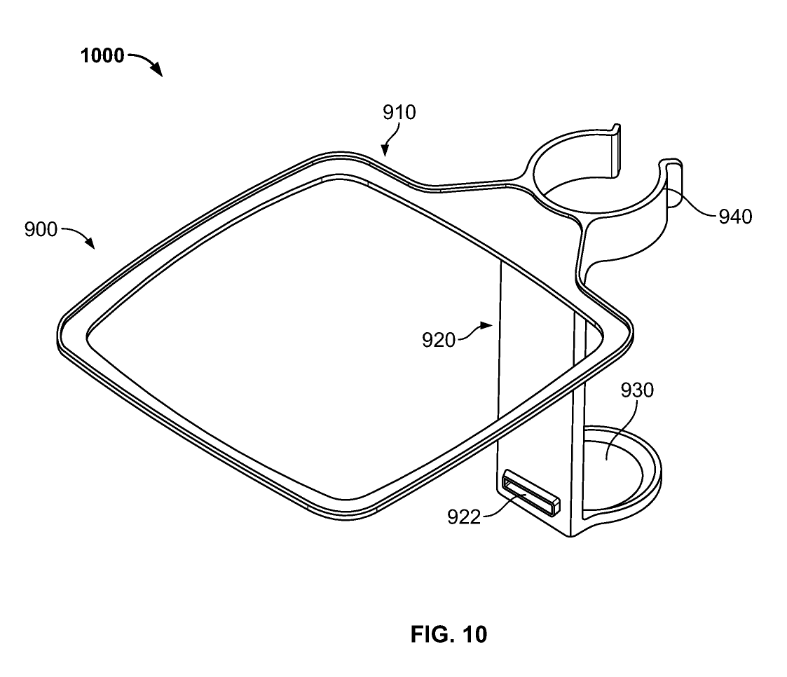

Turning to FIG. 10, there depicted is a prospective elevation view 1000 of tamper holder 900. As seen in view 1000, tamper holder 900 may comprise a bumper 922. Bumper 922 may protrusion that extends from arm 920. It is appreciated that bumper 922 may be any suitable shape. The shape may be cylindrical like, conical like, rectangular like, irregularly shaped, and the likes. More over, bumper 922 may comprise more than one protrusion, each of which may be of different shapes. In at least one embodiment, bumper 922 may comprise one or more layers, such as a hard body layer that is monolithically formed with arm 920 and a bumper pad that may be a rubber pad adhered or otherwise affixed to the hard body layer (e.g., plastic or other material).

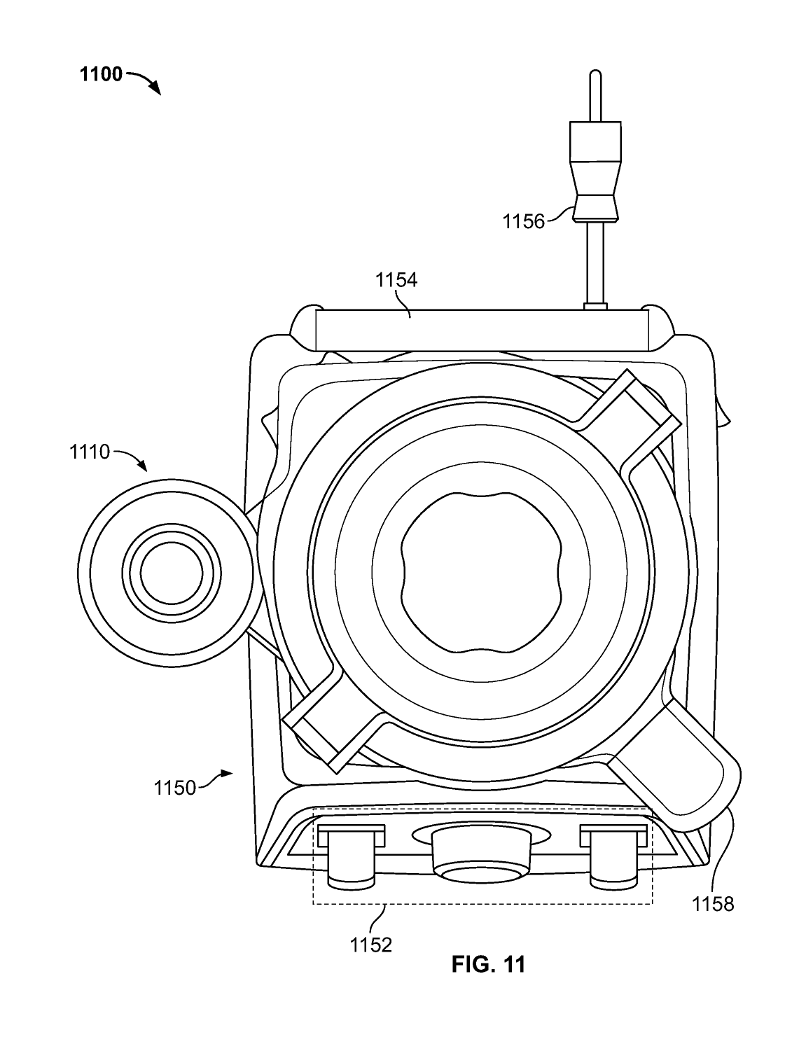

FIG. 11 depicts a top view of a blender system 1100 comprising a tamper and tamper holder 1110 (e.g., tamper holder 100, 500, 900, etc.). As described herein, tamper holder 1110 may be connected to blender base 1150. The position of tamper holder 1110 may depend on the position of various other components of blender system 1100. For instance, tamper holder 1110 may be positioned to avoid contact with or obstruction of control panel 1152, vent 1154, cord 1156, or handle 1158. It is noted that blender system 1100 may comprise different components and/or configurations. As such FIG. 11 depicts an exemplary blending system 1100 of other exemplary blending systems.

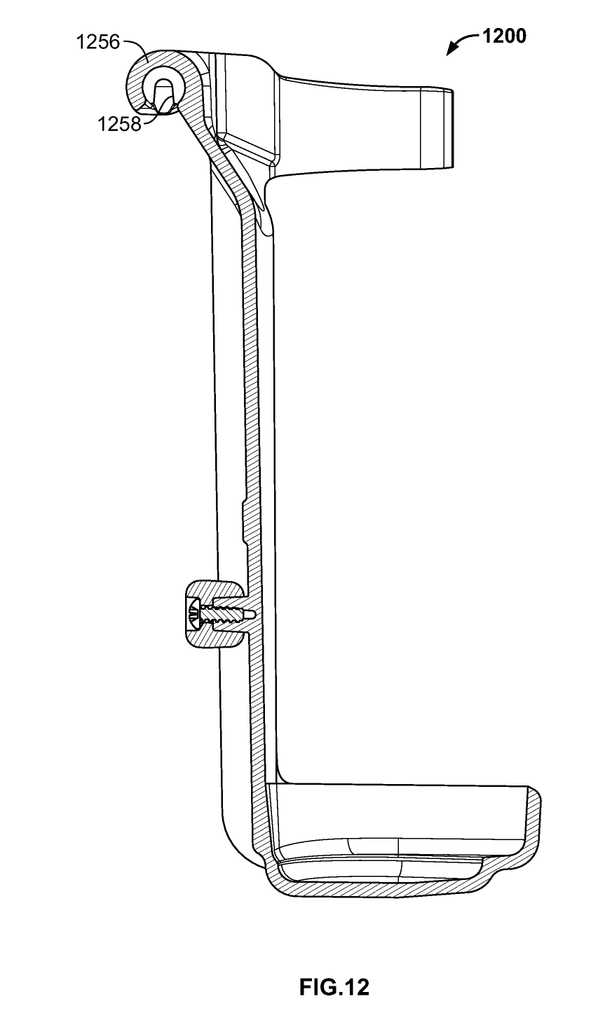

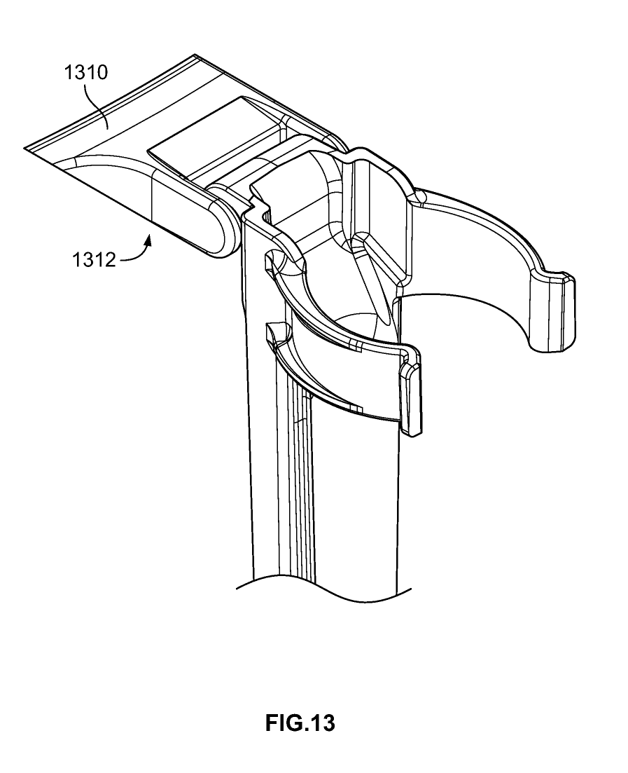

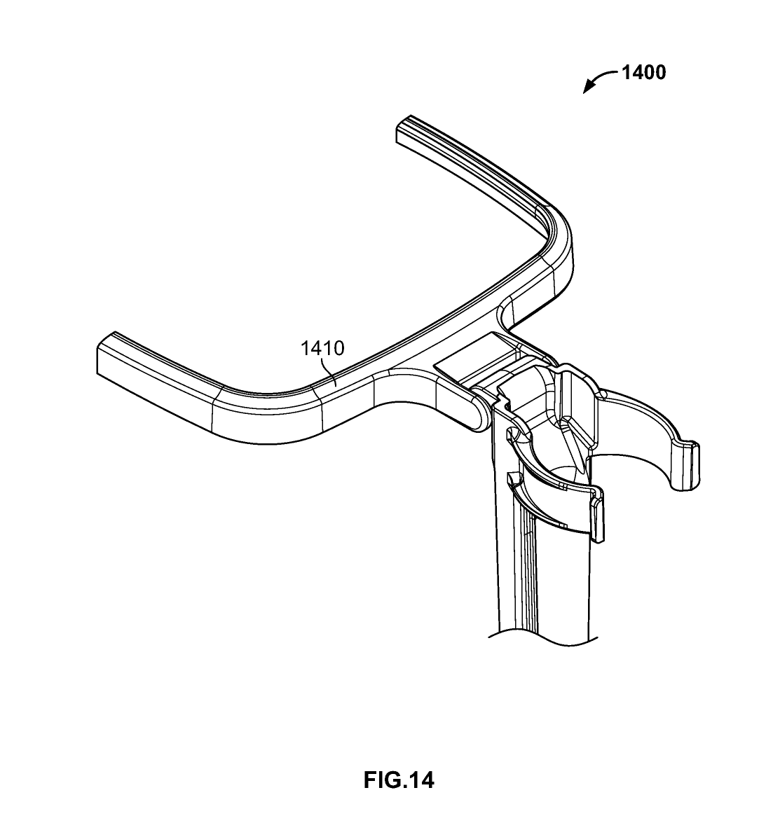

FIGS. 12-17 depict various embodiments of tamper holders 1200, 1300, 1400, 1500, 1600, and 1700. These embodiments may comprise other components not shown for brevity. As depicted tamper holder 1200 is a cross sectional view of tamper holder 1200. Tamper holder 1200 may comprise a connection component 1256 that may couple or be connected to an appropriate mating connection component 1258 of another system (e.g., blender base, pedestal, attachment pad, container, or the likes). In some embodiments, the other system may comprise a plurality of mating connection components such that a user may determine a desired position for attaching tamper holder 1200. Connection component 1256 may be generally c-shaped or o-shaped such that it may at least partially wrap around mating connection component 1258 (e.g., a pin, screw, rod, etc.).

Tamper holder 1300 may comprise a shortened attachment pad 1310. In embodiments, attachment pad 1310 may connect to a larger system (e.g., blender base, pedestal, container, or the likes). A reverse or bottom side 1312 of attachment pad 1310 may comprise mechanism for connecting to the larger system. The mechanism for connecting may comprise VELCRO, buttons, adhesive, a cleated connection system, magnets, or the likes.

Tamper holder 1400 may comprise attachment pad 1410. Attachment pad 1410 may comprise a general c-shape or other desired shape. Attachment pad 1410 may comprise cleats or other means of connection as described with reference to various embodiments disclosed herein.

FIG. 15 depicts an embodiment of tamper holder 1500 wherein an attachment pad 1510 may comprise a strap of cord. The strap may comprise a VELCRO strap, a buckle, an adjustable buckle, a flexible or elastic material (e.g., rubber), and the likes. The strap may pass through aperture 1512 or connect with tamper holder 1500 at aperture 1512. In embodiments, the strap may at least partially wrap around a portion of a larger system (e.g., blender system). In some embodiments, the strap may wrap completely around a portion of the blender system and may fasten to itself. In at least one embodiment, the strap may connect to a portion of the blender system. For example, the blender system may comprise VELCRO pads positioned on a blender base that may connect to VELCRO on one or more portions of the strap.

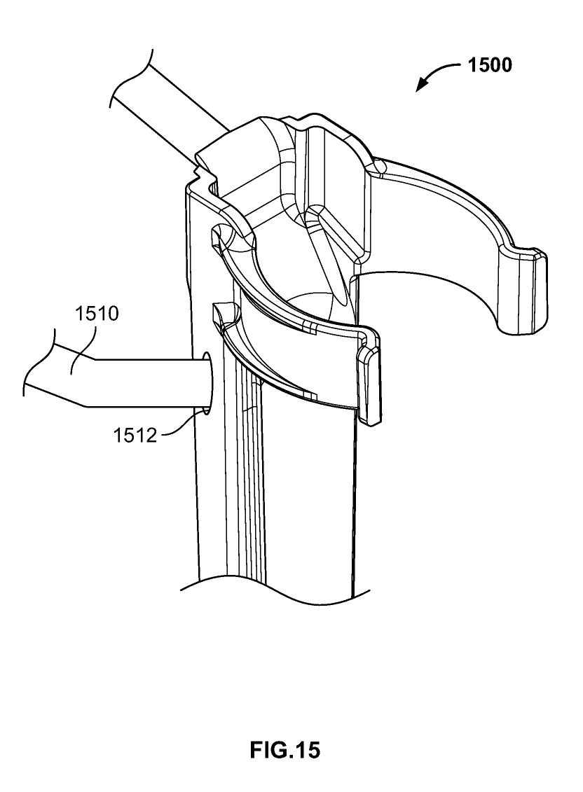

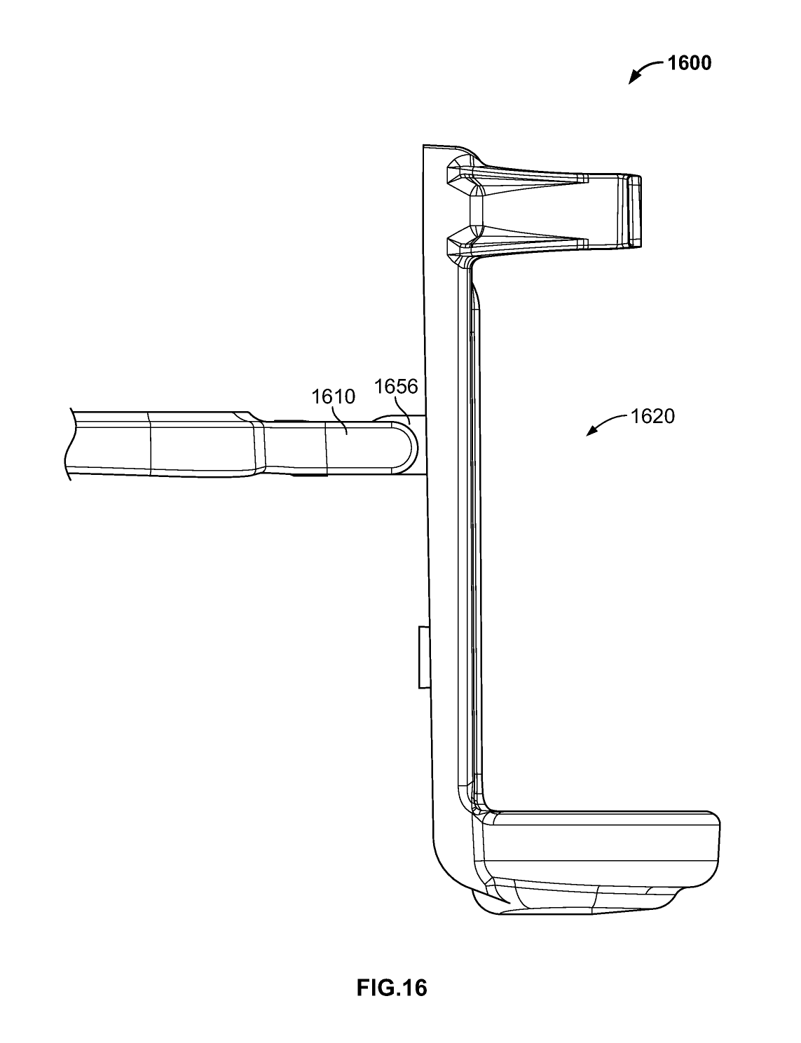

FIG. 16 depicts tamper holder apparatus 1600 comprising arm 1620 connected to attachment pad 1610 at arm attachment component 1656. As depicted arm 1620 is attached to attachment pad 1610 at a point along a support of arm 1620. In such a configuration, a tamper handle may be closer to a top of a container. In another aspect, a collar of a tamper handle may be clear of interference with other components. In some embodiments, the connection location of arm 1620 and attachment pad 1610 may be moveable. For instance, arm 1620 can be attached to attachment pad 1610 at a position similar to that of FIG. 5. Arm 1620 may then be moved (e.g., slide, removed and reattached, etc.) as shown in FIG. 16.

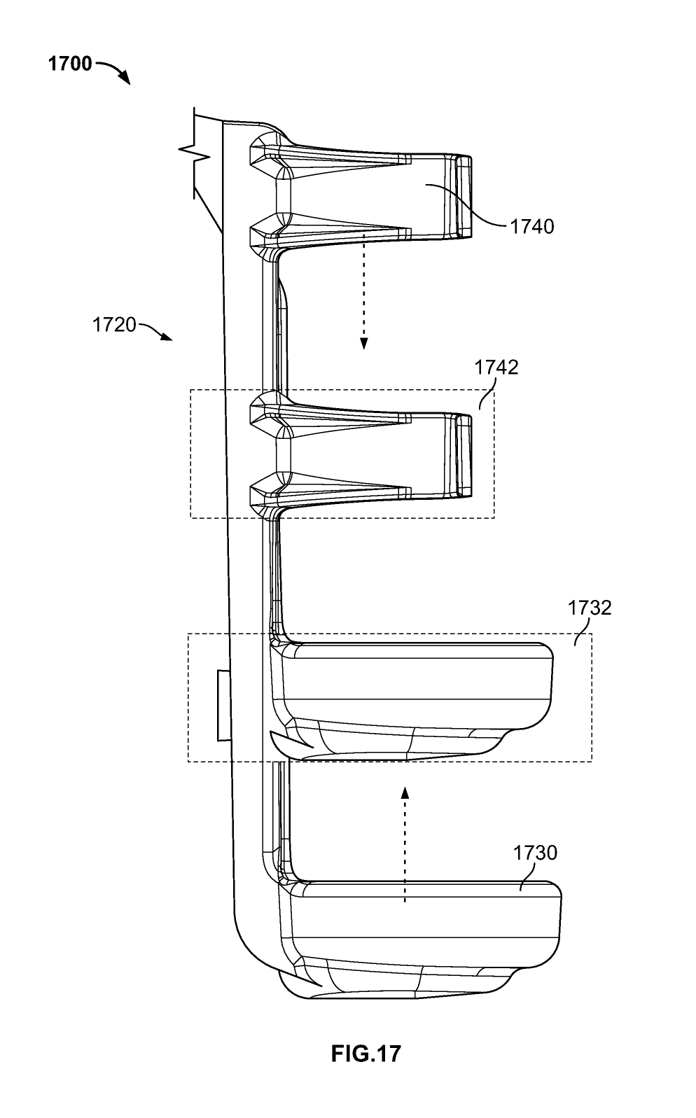

FIG. 17 depicts tamper holder apparatus 1700 comprising a movable clasp component 1740 and a movable spill moat 1730. The clasp component 1740 and spill moat 1730 may be movable along arm 1720. For example, spill moat 1730 may be moved to position 1732. Likewise, clasp component 1740 may be moved to position 1742. A user may move the clasp component 1740 and/or spill moat 1730 as they so desire. In another aspect, the clasp component 1740 and/or spill moat 1730 may be moved to facilitate packaging, storage, or proper holding of a tamper.

In view of the subject matter described herein, methods that may be related to various embodiments may be better appreciated with reference to the flowcharts of FIGS. 18-19. While the methods are shown and described as a series of blocks, it is noted that associated methods or processes are not limited by the order of the blocks. It is further noted that some blocks and corresponding actions may occur in different orders and/or concurrently with other blocks. Moreover, different blocks or actions may be utilized to implement the methods described hereinafter. Various actions may be completed by one or more of users, mechanical machines, automated assembly machines (e.g., including one or more processors or computing devices), or the like.

FIG. 18 depicts an exemplary flowchart of non-limiting method 1800 associated with attaching a tamper holder to a blender device, according to various aspects of the subject disclosure. As an example, method 1800 may enable connection of a tamper holder with sensory feedback information that indicates a proper or acceptable connection.

At 1802, an attachment pad may be positioned (e.g., via a user, assembly device, etc.) relative to a blender base. It is noted that markings, RFID tags, lasers, and the like may be used to position the attachment pad and/or assist in positioning of the attachment pad. In some examples, an end user may position the attachment pad to properly position components of a tamper holder. For instance, a user may position a tamper holder such that an arm of the tamper holder does not interfere with a control panel of the blender base.

At 1804, force may be applied to the attachment pad and/or blender base. Force may include a user manually pushing or pressing the attachment pad, a machine pressing the attachment pad, a user screwing on or rotating the attachment pad, and the likes.

At 1806, sensory feedback may be generated (e.g., via a blender system) indicating at least a partial connection of the attachment pad and the blender base. For example, when a cleat (e.g., one or more coupling components 554) of an attachment pad is pressed into place to engage with a blender base, an audible, visual, or tactile queue may be generated. In this manner, a user may receive sensory information indicating at least a partial connection between the attachment pad and the blender base. In an aspect, cleats that have not engage may

FIG. 19 depicts an exemplary flowchart of non-limiting method 1900 associated with assembling, packaging or folding of a tamper holder, according to various aspects of the subject disclosure. As an example, method 1900 may enable secure and space reducing packaging of a tamper holder.

At 1902, an attachment pad and an arm may be attached (e.g., via arm attachment component 556). It is noted that some embodiments may require permanent attachment of the arm and attachment pad. At 1904, the arm and attachment pad may be positioned. For example, an attachment component may include a hinge or other structure capable of manipulating relative positions of the arm and the attachment pad.

At 1906, an insert (e.g., insert 814) may be provided. It is noted that the insert may connect to one or more components of a tamper holder. Furthermore, the insert may provide structural support, use instructions, tracking information, bar codes, and the like. At 1308, the tamper holder may be packaged in a packaging material, such as a bag, envelope or wrap.

The described embodiments of the subject disclosure, including what is described in the Abstract, is not intended to be exhaustive or to limit the disclosed embodiments to the precise forms disclosed. It is, of course, not possible to describe every conceivable combination of components or methodologies for purposes of describing the claimed subject matter. Thus, it is noted that many other embodiments of the subject innovation are possible and envisioned. Accordingly, the claimed subject matter is intended to embrace all such embodiments that fall within the scope and spirit of the claimed subject matter. Moreover, use of the term “an embodiment” or “one embodiment” throughout is not intended to mean the same embodiment unless specifically described as such.

The words “example” or “exemplary” are used herein to mean serving as an example, instance, or illustration. Any aspect or design described herein as “exemplary” is not necessarily to be construed as preferred or advantageous over other aspects or designs. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. More over, while a particular feature of the subject innovation may have been disclosed with respect to only one of several implementations, such feature may be combined with one or more other features of the other implementations as may be desired and advantageous for any given or particular application.

Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

Moreover, it is to be appreciated that various devices described herein may include computer devices and/or electrical circuit(s) that may include components and circuitry elements of suitable value in order to implement the embodiments of the subject innovation(s). Furthermore, it can be appreciated that many of the various components can be implemented on one or more integrated circuit (IC) chips. For example, a blender system may include one or more IC chips configured to perform operations and/or control components of a blender system.

What is claimed is:

1. A tamper holder apparatus comprising:
an attachment pad configured to attach to a mixing system; and
an arm extending from the attachment pad and configured to hold a tamper, the arm comprising a spill moat.

2. The tamper holder device of claim 1, wherein the arm further comprises:
a clasp component configured to stabilize at least a portion of the tamper.

3. The tamper holder device of claim 1, wherein the arm further comprises:
a bumper extending from the arm, wherein when the tamper holder device is connected to the mixing system the bumper contacts at least a portion of the mixing system.

4. The tamper holder device of claim 3, wherein the bumper comprises a removable pad.

5. The tamper holder device of claim 4, wherein the removable pad comprises a first side comprising a first pitch and a second side comprising a second pitch.

6. The tamper holder device of claim 1, wherein the spill moat comprises a bowl shape.

7. The tamper holder device of claim 6, wherein a position of the bumper is alterable with respect to a distal end of the arm.

8. The tamper holder device of claim 7, wherein the spill moat is further configured to provide support to at least a portion of the tamper.

9. The blending device of claim 1, wherein at least one of the attachment pad or the arm comprise a copolyester material.

10. A blending system comprising:
a tamper holder apparatus configured to hold a tamper and comprising:
an attachment pad configured to connect to at least one other component of the blending system via a coupling component, wherein the attachment pad further comprises:
a clean out portion configured to receive at least a portion of spilled contents; and
an arm extending from the attachment pad and comprising:
a clasp component configured for securing at least a portion of a the tamper; and
a spill moat configured for collecting spilled contents from at least the tamper.

11. The blending device of claim 10, wherein the coupling component further comprise at least one cleat that connects to the at least one other component.

12. The blending device of claim 10, wherein the coupling component is further configured to generate a sensory feedback when a connection state between the coupling component and the blending system alters.

13. The blending device of claim 10, wherein the sensory feedback comprise a tactile feedback.

14. The blending device of claim 10, wherein the at least one other component comprises at least one component selected from a group of components comprising a blender base, a blender pedestal, and a container.

15. The blending device of claim 10, wherein the tamper pad comprises a closed frame shape configured to fit around a pedestal of the blending system.

16. The blending device of claim 10, wherein the tamper pad comprise a flap portion extending from a side of the tamper pad and configured to aid in detaching the tamper pad from at least one other component of the blending system.

17. A blending system comprising:
a tamper holder configured to attach to a blender base, wherein the tamper holder comprises:
an attachment portion coupled to an arm portion, wherein relative positions of the attachment portion and the arm portion are alterable;
wherein the arm portion further comprises a
a clasp component configured for receiving a tamper;
a support component extending from the clasp component; and
a spill moat component extending perpendicularly from the support component at a distal end, in comparison with a location of the clasp component, of the support component; and
wherein a distance between the clasp component and the spill moat component is based on a dimension of the tamper.

18. The blending system of claim 17, further comprising an arm attachment component configured to adjust a position of the arm portion relative to a position of the attachment portion.

19. The blending system of claim 17, wherein the arm portion is parallel to the attachment portion in a first position, and wherein the arm portion is perpendicular to the attachment portion in a second position.

20. The blending system of claim 17, wherein, when the tamper holder is attached to the blender base, the arm portion is adjacent to a side of the blender that does not comprise at least one of a vent, a power cord, or a control panel.
